(19) United States
(12) Patent Application Publication
(10) Pub. No.: US 2025/0190155 A1
(43) Pub. Date: Jun. 12, 2025

(54) IMAGE FORMING APPARATUS, IMAGE FORMING METHOD, AND STORAGE MEDIUM

(71) Applicant: Konica Minolta, Inc., Tokyo (JP)

(72) Inventors: Natsuyo IDA, Toyokawa-shi (JP); Takahiro TSUJIMOTO, Toyokawa-shi (JP); Noriyuki JINBO, Hamamatsu-shi (JP); Akinori KIMATA, Toyokawa-shi (JP)

(21) Appl. No.: 18/972,310

(22) Filed: Dec. 6, 2024

(30) Foreign Application Priority Data
Dec. 11, 2023 (JP) 2023-208147

(51) Int. Cl. G06F 3/12

(52) U.S. Cl. CPC G06F 3/121; G06F 3/1204; G06F 3/1234; G06F 3/1253

(57) ABSTRACT

An image forming apparatus includes a setter that sets sheet information on a sheet, a detector that detects sheet information on the sheet, an image former that forms an image on the sheet under an image forming condition determined based on at least one of the sheet information set by the setter and the sheet information detected by the detector, and a hardware processor that determines whether the sheet information set by the setter and the sheet information detected by the detector match, and in response to determining that the sheet information set by the setter and the sheet information detected by the detector do not match, causes a display to display a setting screen related to a sheet in a print job.

### BACKGROUND OF THE INVENTION

### Technical Field

The present invention relates to an image forming apparatus, an image forming method, and a storage medium.

### Description of Related Art

Conventionally, image forming apparatuses that form images on sheets have been known. In a

conventional image forming apparatus, it is possible to perform image formation even when the type of sheets (sheet type) set in a sheet feed tray is different from the type of sheets set by a user. However, depending on the combination of the type of sheets set in a sheet feed tray and the type of sheets set by a user, malfunction may occur during image formation. Examples of the malfunction include image quality degradation and jam occurrence. Then, in Japanese Unexamined Patent Publication No. 2021-39178, there is disclosed a configuration in

which the type of a sheet fed is automatically detected by a sensor provided on a sheet conveyance path. In the configuration disclosed in Japanese Unexamined Patent Publication No. 2021-39178, it is determined whether the detected sheet type and the set sheet type by the user satisfy a prohibition condition. When the prohibition condition is satisfied, a warning related to image formation is displayed according to a predetermined condition. Thus, it is possible to prevent image quality deterioration, jam occurrence and the like in image formation

### SUMMARY OF THE INVENTION

The configuration disclosed in Japanese Unexamined Patent Publication No. 2021-39178 displays a warning if the detected sheet type and the set sheet type by the user satisfy the prohibition condition. Meanwhile, the configuration disclosed in Japanese Unexamined Patent Publication No. 2021-39178 keeps printing if the prohibited condition is not satisfied even if the sheet types are different from one another.

However, when the sheet types are different from one another, image formation cannot be performed under an appropriate image forming condition(s). Therefore, even if the prohibition condition is not satisfied, malfunction may be caused. In addition, since the user does not know the cause of malfunction, occurrence of malfunction may be repeated.

An object of the present invention is to provide an image forming apparatus, an image forming method and a storage medium storing a program that are capable of improving the quality of an image formed on a sheet while suppressing occurrence of malfunction.

To achieve at least one of the abovementioned objects, according to an aspect of the present invention, an image forming apparatus reflecting one aspect of the present invention includes:
a setter that sets sheet information on a sheet;
a detector that detects sheet information on the sheet;
an image former that forms an image on the sheet under an image forming condition determined based on at least one of the sheet information set by the setter and the sheet information detected by the detector; and
a hardware processor that determines whether the sheet information set by the setter and the sheet information detected by the detector match, and in response to determining that the sheet information set by the setter and the sheet information detected by the detector do not match, causes a display to display a setting screen related to a sheet in a print job.

According to an aspect of the present invention, an image forming method reflecting one aspect of the present invention is performed by an image forming apparatus including a setter that sets sheet information on a sheet, a detector that detects sheet information on the sheet, and an image former that forms an image on the sheet under an image forming condition determined based on at least one of the sheet information set by the setter and the sheet information detected by the detector; and includes:
determining whether the sheet information set by the setter and the sheet information detected by the detector match; and
in response to determining that the sheet information set by the setter and the sheet information detected by the detector do not match, causing a display to display a setting screen related to a sheet in a print job.

According to an aspect of the present invention, a non-transitory computer-readable storage medium reflecting one aspect of the present invention stores a program causing, of an image forming apparatus including a setter that sets sheet information on a sheet, a detector that detects sheet information on the sheet, and an image former that forms an image on the sheet under an image forming condition determined based on at least one of the sheet information set by the setter and the sheet information detected by the detector, a computer to perform:
determining whether the sheet information set by the setter and the sheet information detected by the detector match; and
in response to determining that the sheet information set by the setter and the sheet information detected by the detector do not match, causing a display to display a setting screen related to a sheet in a print job.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a diagram illustrating a schematic configuration of an image forming apparatus according to the present embodiment;

FIG. 2 is a functional block diagram illustrating a control structure of the image forming apparatus according to the present embodiment;

FIG. 3 is a flowchart showing an example of control of the image forming apparatus according to the present embodiment;

FIG. 4 shows an example of a sheet information setting change screen;

FIG. 5 shows an example of a state in which a message that a setting method of sheet information has been changed to automatic setting is displayed on a display part; and

FIG. 6 shows an example of a state in which a message that setting of sheet information has been changed to detection information is displayed on the display part.

### DETAILED DESCRIPTION

Hereinafter, one or more embodiments of the present invention will be described in detail with reference to the drawings. However, the scope of the present invention is not limited to the embodiments below or illustrated examples.

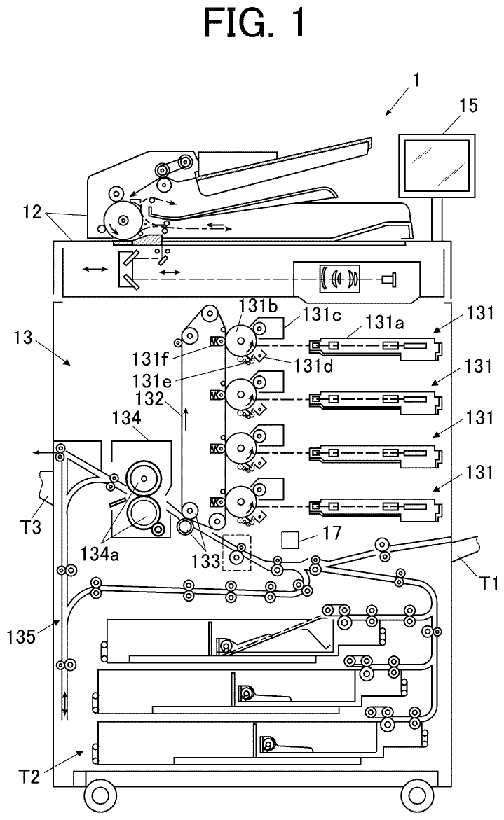

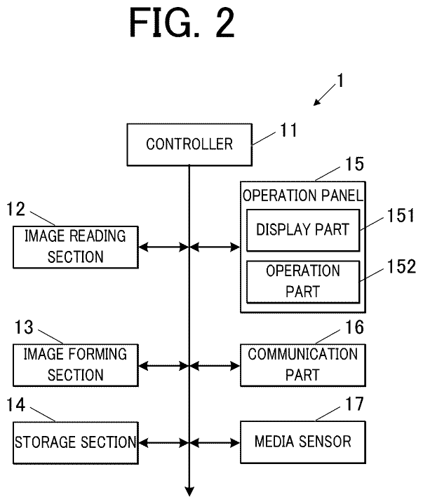

As illustrated in FIGS. 1 and 2, an image forming apparatus 1 according to the present embodiment includes a controller 11 (hardware processor), an image reading section 12, an image forming section 13 (image former), a storage section 14 (storage), an operation panel 15, a communication part 16, and a media sensor 17 (detector).

The controller 11 includes a CPU, a RAM, a ROM, and the like. In response to instruction signals, the CPU reads various process programs stored in the ROM and develops them in the RAM. The instruction signals are operation signals input from an operation part 152 (setter) or received by the communication part 16. The CPU integrally controls the operation of the image forming apparatus 1 in cooperation with the various programs developed in the RAM.

The image reading section 12 reads an image of a document placed on a document plate or an automatic document feeder (ADF) (not illustrated) and obtains an image signal. Specifically, the image reading section 12 performs scanning and exposure on the image of the document with an optical system of a scanning-exposure device, and reads reflected light thereof with a line image sensor, thereby obtaining an image signal. The image signal is subjected to processing such as A/D conversion, shading correction and/or compression, and then input as image data to the controller 11. The image data input to the controller 11 is not limited to the image data read by the image reading section 12. For example, the image data may be image data received from an external apparatus (not illustrated) via the communication part 16.

The image forming section 13 forms an image composed of four colors of C, M, Y, and K on a sheet in accordance with pixel values of four colors of each pixel of the original image subjected to image processing.

The image forming section 13 includes four writing sections 131, an intermediate transfer belt 132, secondary transfer rollers 133, a fixing section 134, and the like.

The four writing sections 131 are arranged in series (tandem) along the belt surface of the intermediate transfer belt 132 to form C, M, Y and K images. The writing sections 131 have the same configuration except that they form images in different colors. Each of the writing sections 131 includes an optical scanning section 131a, a photoreceptor 131b, a developing section 131c, a charging section 131d, a cleaning section 131e, and a primary transfer roller 131f.

At the time of image formation, in each writing section 131, first, the charging section 131d charges the photoreceptor 131b. Next, the photoreceptor 131a is scanned with a light beam emitted from the optical scanning section 131b on the basis of the original image, so that an electrostatic latent image is formed. The developing section 131c supplies a color material such as a toner for development, so that an image (toner image) is formed on the photoreceptor 131b.

The images formed on the respective photoreceptors 131b of the four writing sections 131 are sequentially superimposed and transferred onto the intermediate transfer belt 132 by the primary transfer rollers 13 1f (primary transfer). Thus, an image composed of the colors is formed on the intermediate transfer belt 132. The intermediate transfer belt 132 is an image bearing member that is wound around a plurality of rollers and rotates. After the primary transfer, the cleaning section 131e removes the color material remaining on the photoreceptor 131b.

In the image forming section 13, a sheet is fed in accordance with the timing at which the image on the rotating intermediate transfer belt 132 reaches the position of the secondary transfer rollers 133. In the image forming section 13, the sheet is fed from a manual sheet feed tray T1 or a sheet feed tray(s) T2. One of the paired secondary transfer rollers 133 comes into contact with the intermediate transfer belt 132 by pressure. Further, the other roller thereof constitutes one of the plurality of rollers around which the intermediate transfer belt 132 is wound. Next, the image is transferred from the intermediate transfer belt 132 onto the sheet by the pressure contact of the secondary transfer roller 133 (secondary transfer). Next, the sheet is conveyed to the fixing section 134, subjected to fixing, and ejected to a sheet ejection tray T3. The fixing is a process in which fixing rollers 134a apply heat and pressure to the sheet to fix the image to the sheet. In a case of forming images on both sides of the sheet, the sheet is conveyed to a reversing path 135 to reverse the sheet surface, and then the sheet is fed again to the position of the secondary transfer rollers 133.

The storage section 14 is a nonvolatile storage means configured by an HDD, an SSD, and/or the like. The storage section 14 stores various programs, various setting data, and the like so as to be readable and writable from the controller 11.

The operation panel 15 includes a display part 151 that displays various types of information to a user and the operation part 152 that receives operation inputs by the user.

The display part 151 is configured by a color liquid crystal display or the like, and displays an operation screen or the like in accordance with a display control signal input from the controller 11. Examples of the operation screen include various setting screens, various buttons, and operation states of various functions.

The operation part 152 includes a touch screen provided on the screen of the display part 151 and various hard keys arranged around the screen of the display part 151. When a button displayed on the screen is pressed with a finger, a touch pen, or the like, first, the operation part 152 detects XY coordinates of the pressed point with a voltage value. Next, the operation part 152 outputs an operation signal associated with the detected position to the controller 11. Note that the touch screen is not limited to a pressure-sensitive type, but may be, for example, an electrostatic type, an optical type, or the like. When a hard key is pressed, the operation part 152 outputs an operation signal associated with the pressed key to the controller 11. The user can make settings related to image formation, a sheet conveyance instruction, an apparatus's stop operation, and the like by operating the operation part 152. The settings related to image formation include, for example, image quality setting, magnification setting, application setting, output setting, and sheet setting.

The communication part 16 is an interface that includes a communication IC and a communication connector and connects the image forming apparatus 1 to a communication network. The communication part 16 transmits and receives various types of information to and from an external apparatus connected to the communication network using a predetermined communication protocol under the control of the controller 11. Furthermore, the communication part 16 can also input and output various types of information via a USB.

The media sensor 17 is provided on a conveyance path of the sheet toward the image forming section 13. The media sensor 17 reads the sheet fed from the manual sheet feed tray TI or the sheet feed tray T2 and detects sheet information on the sheet. The sheet information is information including the sheet type of a sheet. The detected sheet information is output to the controller 11. That is, the media sensor 17 functions as a detector of the present invention that detects the sheet information on the sheet.

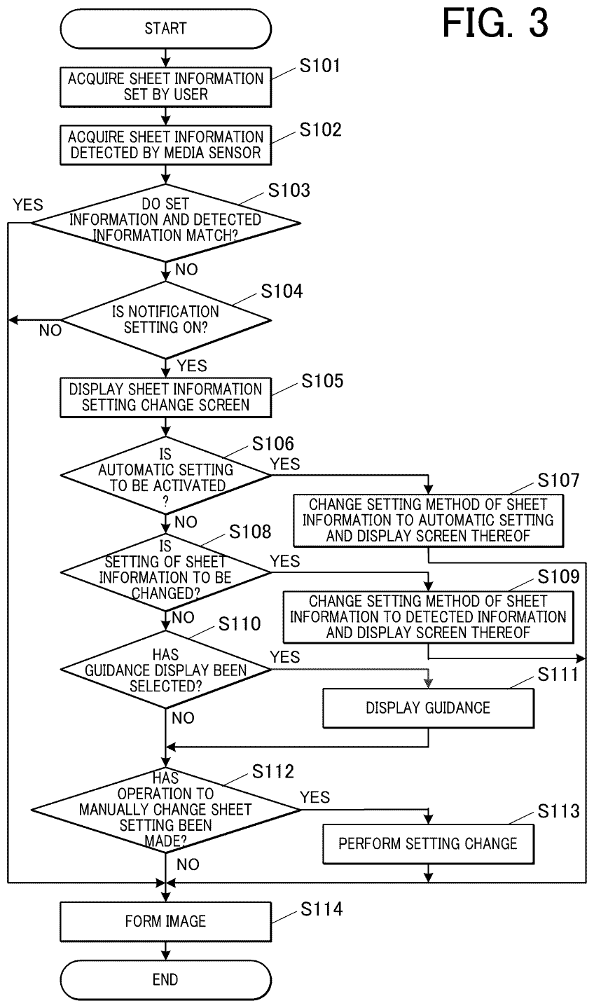

Next, control by the image forming apparatus 1 according to the present embodiment will be described with reference to a flowchart shown in FIG. 3. The control shown in FIG. 3 is started when a print job is input.

First, the controller 11 acquires sheet information set by the user via the operation part 152 (Step S101). That is, the operation part 152 functions as a setter of the present invention that sets sheet information on a sheet. The sheet information is information including the sheet type of a sheet.

Next, the controller 11 acquires sheet information detected by the media sensor 17 (Step S102).

Next, the controller 11 determines whether the sheet information (set information) acquired in Step S101 and the sheet information (detected information) acquired in Step S102 match (Step S103). That is, the controller 11 functions as a determiner of the present invention that determines whether the sheet information set by the operation part 152 and the sheet information detected by the media sensor 17 match.

If the controller 11 determines that the sheet information set by the operation part 152 and the sheet information detected by the media sensor 17 match (Step S103: YES), the controller 11 proceeds to Step S114 without setting change.

On the other hand, if the controller 11 determines that the sheet information set by the operation part 152 and the sheet information detected by the media sensor 17 do not match (Step S103: NO), the controller 11 proceeds to the next Step S104.

Next, the controller 11 determines whether notification setting is ON (Step S104). The notification setting is the setting to notify the user that the sheet information set by the operation part 152 and the sheet information detected by the media sensor 17 do not match. The notification to the user is performed by causing the display part 151 to display a message that the sheet information set by the operation part 152 and the sheet information detected by the media sensor 17 do not match.

If the controller 11 determines that the notification setting is ON (Step S104: YES), the controller 11 proceeds to the next Step S105.

On the other hand, if the controller 11 determines that the notification setting is not ON (is OFF) (Step S104: NO), the controller 11 proceeds to Step S114 without setting change. In this case, even when the sheet information set by the operation part 152 and the sheet information detected by the media sensor 17 do not match, printing continues.

Next, the controller 11 causes the display part 151 to display a screen (sheet information setting change screen G1) for changing the setting related to the sheet information (sheet type) (Step S105).

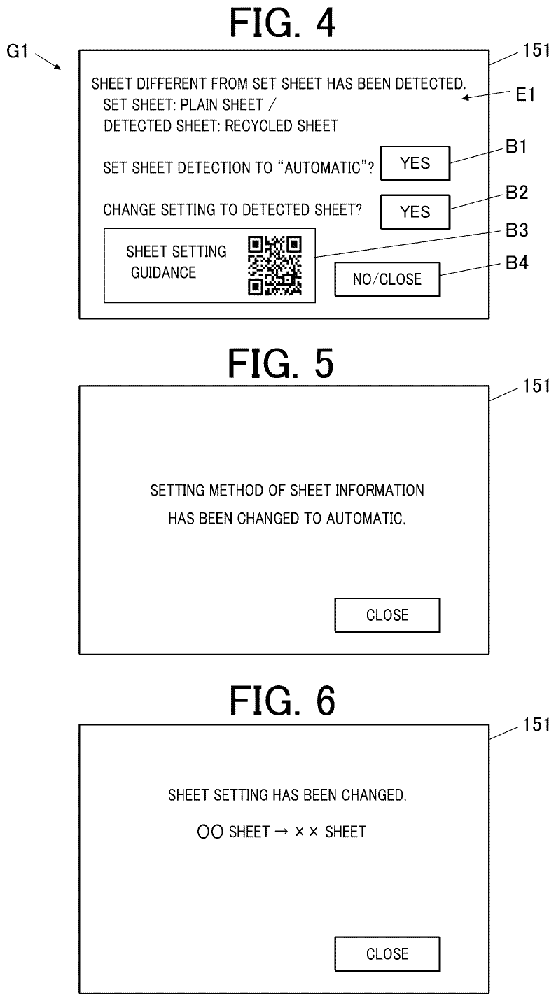

FIG. 4 shows an example of the sheet information setting change screen G1.

The sheet information setting change screen G1 is provided with an automatic setting button B1, a setting change button B2, a guidance display button B3, and a close button B4. The automatic setting button B1 is a button for changing the setting method of the sheet information from manual setting to automatic setting. The manual setting is the setting by the user via the operation part 152. The automatic setting is the setting to automatically set the sheet information detected by the media sensor 17. The setting change button B2 is a button for changing the setting from the sheet information set by the manual setting to the sheet information detected by the media sensor 17. The guidance display button B3 is a button for displaying guidance for explaining the setting method of the sheet information. The close button B4 is a button for closing the sheet information setting change screen G1.

The setting by the automatic setting button B1 is the setting as to whether to select a mode in which an image forming condition(s) is determined on the basis of the sheet information detected by the media sensor 17 (detected information). In order to select the mode in which the image forming condition is determined on the basis of not the set information but the detected information, the user presses the automatic setting button B1.

The setting by the setting change button B2 is the setting as to whether to determine the image forming condition in the image forming section 13 on the basis of the sheet information detected by the media sensor 17. In order to determine the image forming condition on the basis of not the set information but the detected information, the user presses the setting change button B2.

The setting by the guidance display button B3 is the setting as to whether to display guidance for sheet setting. In order to display the guidance, the user presses the guidance display button B3.

As described above, the sheet information setting change screen G1 includes the setting by the automatic setting button B1, the setting by the setting change button B2, and the setting by the guidance display button B3.

Further, the sheet information setting change screen G1 is provided with a no-match notification area El for notifying the user that the sheet information set by the operation part 152 and the sheet information detected by the media sensor 17 do not match. In the no-match notification area El, the set sheet and the detected sheet are displayed. The set sheet is the sheet information set by the operation part 152. The detected sheet is the sheet information detected by the media sensor 17. In FIG. 4, an example is displayed in which the sheet information set by the operation part 152 and the sheet information detected by the media sensor 17 do not match, namely, the set sheet is “plain sheet”, and the detected sheet is “recycled sheet”. That is, the controller 11 is capable of causing the display part 151 to display the message that the sheet information set by the operation part 152 and the sheet information detected by the media sensor 17 do not match.

Next, the controller 11 determines whether to activate the automatic setting (Step S106). To be specific, the controller 11 determines whether the automatic setting button G1 has been pressed on the sheet information setting change screen B1. If the controller 11 determines that the automatic setting button B1 has been pressed, the controller 11 determines to activate the automatic setting.

If the controller 11 determines to activate the automatic setting (Step S106: YES), the controller 11 proceeds to the next Step S107.

On the other hand, if the controller 11 determines not to activate the automatic setting (Step S106: NO), the controller 11 proceeds to Step S108.

In Step S107, the controller 11 changes the setting method of the sheet information to the automatic setting, and causes the display part 151 to display a screen of the message. Thereafter, the controller 11 ends the process.

FIG. 5 shows an example of the state in which the message that the setting method of the sheet information has been changed to the automatic setting is displayed by the display part 151. In the example shown in FIG. 5, the text “Setting Method of Sheet Information Has Been Changed to Automatic” is displayed.

In Step S108, the controller 11 determines whether to change the setting of the sheet information (sheet setting). To be specific, the controller 11 determines whether the setting change button G1 has been pressed on the sheet information setting change screen B2. If the controller 11 determines that the setting change button B2 has been pressed, the controller 11 determines to change the setting of the sheet information.

If the controller 11 determines to change the setting of the sheet information (Step S108: YES), the controller 11 proceeds to the next Step S109.

On the other hand, if the controller 11 determines not to change the setting of the sheet information (Step S108: NO), the controller 11 proceeds to Step S110.

In Step S109, the controller 11 changes the setting of the sheet information to the detected information, and causes the display part 151 to display a screen of the message. The detected information is the sheet information detected by the media sensor 17. Thereafter, the controller 11 ends the process.

FIG. 6 shows an example of the state in which a message that the setting of the sheet information has been changed to the detected information is displayed by the display part 151. In the example shown in FIG. 6, the text “Sheet Setting Has Been Changed” is displayed. In addition, the message that the sheet setting has been changed from the set information (∘∘ sheet) to the detected information (xx sheet) (∘∘ sheet→xx sheet) is specifically displayed.

In Step S110, the controller 11 determines whether guidance display has been selected. To be specific, the controller 11 determines whether the guidance display button G1 has been pressed on the sheet information setting change screen B3. If the controller 11 determines that the guidance display button B3 has been pressed, the controller 11 determines that the guidance display has been selected.

If the controller 11 determines that the guidance display has been selected (Step S110: YES), the controller 11 proceeds to the next Step S111.

On the other hand, if the controller 11 determines that the guidance display has not been selected (Step S110: NO), the process proceeds to Step S112.

In Step S111, the controller 11 causes the display part 151 to display the guidance for explaining the setting method of the sheet information. The guidance is, for example, a method of presenting detailed information on the sheet type (“Recycled Sheet is . . . Sheet”, etc.) to the user. Additionally or alternatively, a message such as “Please Check Description on Sheet Package being Used” may be presented. Additionally or alternatively, a list of checking items may be displayed, and an OK button(s) (checkbook(s)) may be checked when the checking is completed.

Note that instead of causing the display part 151 to display the guidance, a QR code® may be displayed. In this case, the above-described guidance is displayed on a display part of a terminal that has read the QR code®.

In Step S112, the controller 11 determines whether an operation to manually change the sheet setting has been made by the user.

If the controller 11 determines that the operation to manually change the sheet setting has been made (Step S112: YES), the controller 11 performs setting change in accordance with the operation (Step S113). Thereafter, the controller 11 proceeds to Step S114.

On the other hand, if the controller 11 determines that the operation to manually change the sheet setting has not been made (Step S112: NO), the controller 11 proceeds to Step S114.

In Step S114, the controller 11 controls and causes the image forming section 13 to form an image on a sheet under the image forming condition determined on the basis of the setting of the sheet information (sheet setting). The sheet setting is at least one of the sheet information set by the operation part 152 and the sheet information detected by the media sensor 17. That is, the image forming section 13 forms an image on a sheet under the image forming condition determined on the basis of at least one of the sheet information set by the operation part 152 and the sheet information detected by the media sensor 17. Thereafter, the controller 11 ends the process.

As described above, if the controller 11 determines that the sheet information set by the operation part 152 and the sheet information detected by the media sensor 17 do not match (Step S103: NO), the controller 11 causes the display part 151 to display the setting screen related to a sheet in the print job. Examples of the setting screen related to the sheet include the screens illustrated in FIGS. 4 and 5, and the screen where the guidance is displayed (see Step S111). That is, the controller 11 functions as a display controller of the present invention. Note that in the present embodiment, if the controller 11 determines that the sheet information set by the operation part 152 and the sheet information detected by the media sensor 17 do not match, the controller 11 causes the display part 151 to display a setting screen related to the sheet subsequent to the sheet about which the controller 11 has determined that the sheet information set by the operation part 152 and the sheet information detected by the media sensor 17 do not match.

As described above, the image forming apparatus 1 according to the present embodiment includes the setter (operation part 152), the detector (media sensor 17), the image former (image forming section 13), the determiner (controller 11), and the display controller (controller 11). The setter sets sheet information on a sheet. The detector detects sheet information on the sheet. The image forming section 13 forms an image on the sheet under an image forming condition(s) determined based on at least one of the sheet information set by the setter and the sheet information detected by the detector. The determiner determines whether the sheet information set by the setter and the sheet information detected by the detector match. In response to the determiner determining that the sheet information set by the setter and the sheet information detected by the detector do not match, the display controller causes the display (display part 151) to display a setting screen related to a sheet in a print job.

Therefore, when it is determined that the sheet information set by the setter and the sheet information detected by the detector do not match, the screen for resetting sheet information can be displayed. Thus, image formation can be performed under an appropriate image forming condition(s). Therefore, the image quality of an image formed on a sheet can be improved. In addition, occurrence of malfunction such as occurrence of a jam can be suppressed.

Further, the display controller causes the display part 151 to display, on the setting screen, at least one of: a setting as to whether to select a mode in which the image forming condition is determined based on the sheet information detected by the detector; a setting as to whether to determine the image forming condition in the image forming section 13 based on the sheet information detected by the detector; and a setting as to whether to display guidance for performing a setting of the sheet.

Therefore, when it is determined that the sheet information set by the setter and the sheet information detected by the detector do not match, the screen for resetting sheet information can be displayed. Thus, image formation can be performed under an appropriate image forming condition(s). Therefore, the image quality of an image formed on a sheet can be improved. In addition, occurrence of malfunction such as occurrence of a jam can be suppressed.

The display controller is capable of causing the display part 151 to display a message that the sheet information set by the setter and the sheet information detected by the detector do not match.

Therefore, it is possible to notify the user that the sheet information set by the setter and the sheet information detected by the detector do not match and therefore the setting needs to be changed. Therefore, it is possible to prompt the user to perform setting change of the sheet information.

Further, in response to determining that the sheet information set by the setter and the sheet information detected by the detector do not match, the display controller causes the display part 151 to display a setting screen related to a sheet subsequent to the sheet about which the hardware processor has determined that the sheet information set by the setter and the sheet information detected by the detector do not match.

Therefore, the setting of the sheet information can be changed in real time. Therefore, it is possible to suppress occurrence of malfunction at an earlier stage.

Although the present invention has been described in detail on the basis of the embodiment, the present invention is not limited to the above-described embodiment and can be modified without departing from the scope thereof.

For example, in the above embodiment, when it is determined that the sheet information set by the setter and the sheet information detected by the detector do not match, the setting screen related to the sheet is displayed, but this is not a limitation. For example, when it is determined that the sheet information set by the setter and the sheet information detected by the detector do not match, control to stop the print job in progress may be performed. In this case, the controller 11 functions as a printing controller of the present invention.

As described above, by providing the printing controller (controller 11), it is possible to more reliably suppress occurrence of malfunction. In addition, it is possible to sufficiently secure the time for changing the setting of the sheet information.

When it is determined that the sheet information set by the setter and the sheet information detected by the detector do not match, control may be performed to store the set information (sheet information set by the operation part 152) and the detected information (sheet information detected by the media sensor 17) in the storage section 14. When it is determined that the sheet information set by the setter and the sheet information detected by the detector do not match, control may be performed to transmit the set information and the detected information to the outside (a server apparatus or the like). In this case, the controller 11 functions as an information controller of the present invention.

As described above, by providing the information controller (controller 11), it is possible to accumulate pieces of information in the case where the sheet information set by the setter and the sheet information detected by the detector do not match. This makes it possible to analyze the cause of no-match of the sheet information set by the setter and the sheet information detected by the detector. Therefore, it is possible to suppress no-match of the sheet information set by the setter and the sheet information detected by the detector.

Besides, the detailed configuration and the detailed operation of each device constituting the image forming apparatus can also be appropriately modified without departing from the scope of the present invention.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2023-208147, filed on Dec. 11, 2023, including description, claims, drawings and abstract is incorporated herein by reference.

What is claimed is:

1. An image forming apparatus comprising:
a setter that sets sheet information on a sheet;
a detector that detects sheet information on the sheet;
an image former that forms an image on the sheet under an image forming condition determined based on at least one of the sheet information set by the setter and the sheet information detected by the detector; and
a hardware processor that determines whether the sheet information set by the setter and the sheet information detected by the detector match, and in response to determining that the sheet information set by the setter and the sheet information detected by the detector do not match, causes a display to display a setting screen related to a sheet in a print job.

2. The image forming apparatus according to claim 1, wherein the hardware processor causes the display to display, on the setting screen, at least one of: a setting as to whether to select a mode in which the image forming condition is determined based on the sheet information detected by the detector; a setting as to whether to determine the image forming condition in the image former based on the sheet information detected by the detector; and a setting as to whether to display guidance for performing a setting of the sheet.

3. The image forming apparatus according to claim 1, wherein the hardware processor is capable of causing the display to display a message that the sheet information set by the setter and the sheet information detected by the detector do not match.

4. The image forming apparatus according to claim 1, wherein in response to determining that the sheet information set by the setter and the sheet information detected by the detector do not match, the hardware processor performs control to stop the print job in progress.

5. The image forming apparatus according to claim 1, wherein in response to determining that the sheet information set by the setter and the sheet information detected by the detector do not match, the hardware processor causes the display to display a setting screen related to a sheet subsequent to the sheet about which the hardware processor has determined that the sheet information set by the setter and the sheet information detected by the detector do not match.

6. The image forming apparatus according to claim 1, wherein in response to determining that the sheet information set by the setter and the sheet information detected by the detector do not match, the hardware processor performs control to store the sheet information set by the setter and the sheet information detected by the detector in a storage or to transmit the sheet information set by the setter and the sheet information detected by the detector to outside.

7. An image forming method that is performed by an image forming apparatus including a setter that sets sheet information on a sheet, a detector that detects sheet information on the sheet, and an image former that forms an image on the sheet under an image forming condition determined based on at least one of the sheet information set by the setter and the sheet information detected by the detector; comprising:
determining whether the sheet information set by the setter and the sheet information detected by the detector match; and
in response to determining that the sheet information set by the setter and the sheet information detected by the detector do not match, causing a display to display a setting screen related to a sheet in a print job.

8. A non-transitory computer-readable storage medium storing a program causing, of an image forming apparatus including a setter that sets sheet information on a sheet, a detector that detects sheet information on the sheet, and an image former that forms an image on the sheet under an image forming condition determined based on at least one of the sheet information set by the setter and the sheet information detected by the detector, a computer to perform:
determining whether the sheet information set by the setter and the sheet information detected by the detector match; and
in response to determining that the sheet information set by the setter and the sheet information detected by the detector do not match, causing a display to display a setting screen related to a sheet in a print job.
